(19) United States
(12) Patent Application Publication
(10) Pub. No.: US 2002/0106020 A1
(43) Pub. Date: Aug. 8, 2002

(54) Fast method for the forward and inverse MDCT in audio coding

(76) Inventors: T. C. Cheng, San Marino, CA (US); T. K. Truong, San Marino, CA (US); J. M. Kuo, Ta-Hsu Hsiang (TW); J. H. Jeng, Ta-Hsu Hsiang (TW); S. L. Fu, Ta-Hsu Hsiang (TW)

Correspondence Address: CHRISTIE, PARKER & HALE, LLP, 350 WEST COLORADO BOULEVARD, SUITE 500, PASADENA, CA, 91105, US

(21) Appl. No.: 09/780,699

(22) Filed: Feb. 9, 2001

Related U.S. Application Data
(60) Provisional application No. 60/181,271, filed on Feb. 9, 2000.
(60) Provisional application No. 60/184,685, filed on Feb. 24, 2000.

(51) Int. Cl. G10L 19/00; H04B 1/66; H04N 7/12; H04N 11/02; H04N 11/04

(52) U.S. Cl. 375/240.2

(57) ABSTRACT

The present invention computes a discrete cosine transform (DCT), for example, an 18-point DCT in a fast and efficient manner. Furthermore, using this 18-point DCT method, two new methods are developed to compute the MDCT and its IMDCT, respectively. The number of multiplications and additions needed to implement both of these two new methods are reduced substantially.

### CROSS-REFERENCE TO RELATED APPLICATIONS

This patent application claims the benefit of the filing date of U.S. Provisional patent application Ser. Nos. 60/181,271, filed Feb. 9, 2000 and entitled “Fast Method for the Forward and Inverse MDCT in Audio Coding”; and 60/184,685, filed Feb. 24, 2000 and entitled “Fast Method for the Forward and Inverse MDCT in Audio Coding”, the entire contents of which are hereby expressly incorporated by reference.

### FIELD OF THE INVENTION

The present invention relates to audio and image data compression and decompression applications. More specifically, the invention relates to a system and method for fast computation of modified discrete cosine transform (MDCT) and its inverse modified discrete cosine transform (IMDCT).

### BACKGROUND OF THE INVENTION

Discrete cosine transform (DCT) is used extensively in data compression for image and speech signals. For example, the authors in N. Amed, T. Natarajan, and K. R. Rao, “Discrete Cosine Transform,” IEEE Trans. Commun., vol. COM-23, pp. 90-93, January 1974 [1]; and Man I K Chao and Sang U K Lee, “DCT methods for VLSI parallel Implementations,” IEEE, Trans. On Acoustics, Speech and Signal Processing, vol. 38, no. 1, pp. 121-127, January 1990 [2], the contents of which are hereby incorporated by reference, describe DCT methods for data compression. Many methods have been proposed to compute the DCT. For example, see Nam I R Cho and Sang U K Lee, “DCT Methods for VLSI Parallel Implementations,” IEEE Transactions on Acoustics, Speech and Signal Processing, vol.38, no.1, pp.121-127, January 1990 [11]; and T. K. Truong, I. S. Reed, I. S. Hsu, H. C. Shyu, and H. M. Sho, “A Pipelined Design of a Fast Prime Factor DFT on a Finite Field,” IEEE Trans. Computers, vol. 37, pp. 266-273, March 1988 [12], the contents of which are hereby incorporated by reference.

Recently, Kek in C. W. Kok, “Fast Method for Computing Discrete Cosine Transform,” IEEE Trans. on Signal Processing, vol. 45, no. 3, pp. 757-760, March 1997 [3], the contents of which are hereby incorporated by reference, suggested a new DCT method for computing the DCT of length N=N₁×N₂, where N₁ is an even number and N₂ is an odd number. In this method, the DCT with even length N is decomposed into two DCT's with length N/2. If N/2 is an odd number.

Further, it follows from Michael T. Heideman, “Computation of an Odd Length DCT from a Real-Value DFT of the Same Length,” IEEE trans. on Signal Processing, vol. 40, no. 1, pp. 54-61, January 1992 [4], the contents of which are hereby incorporated by reference, that such a DCT of length N/2 can be computed by the use of the identical length discrete Fourier transform (DFT) method developed by Winograd. This method is described in Dean P. Kolba and Thomas W. Parks, “A Prime Factor FFT Method Using High-Speed Convolution,” IEEE Trans on Acoustics, Speech and Signal processing, vol. ASSP-25, no. 4, pp. 281-294, August 1977 [5]; and S. Winogard, “On Computing the Discrete Fourier Transform,” Mathematics of Computation, vol. 32, no. 141, pp. 175-199, January 1978. [6], the contents of which are hereby incorporated by reference.

By using the ideas in [3, and 4], a fast method can be developed to compute an 18-point DCT. In other words, the standard 18-point DCT is decomposed first into two 9-point DCT. Then, such a 9-point DCT can be implemented by Winograd's DFT method. However, computing the MDCT and its IMDCT of an even length sequence can involve an extensive computation.

Therefore, there is a need for a fast method to compute either the MDCT or IMDCT so that it can be implemented easily on either a processor, such as a digital signal processor (DSP) or computer. Most recently, the author in K. Konstantinides, “Fast Subband Filtering in MPEG Audio Coding,” IEEE Signal Processing Letters, vol. 1, no. 2, pp. 26-28, February 1994 [7], the contents of which are hereby incorporated by reference, suggested that the MDCT and IMDCT in MPEG audio coding can be converted first into the standard DCT and IDCT, respectively. Such a DCT or IDCT can be computed rapidly by the use of Lee's fast method in Byeong Gi Lee, “A New Method to Compute the Discrete Cosine Transform,” IEEE Trans on Acoustics, Speech and Signal processing, vol. ASSP-32, no. 6, pp. 1243-1245, December 1984 [8], the contents of which are hereby incorporated by reference.

### SUMMARY OF THE INVENTION

The modified discrete cosine transform (MDCT) and its inverse modified discrete cosine transform (IMDCT) can involve an extensive computation, for example, in layer III of the MPEG audio coding standard. The present invention computes an 18-point DCT in a fast and efficient manner. Furthermore, using this 18-point DCT method, two new methods are developed to compute the MDCT and its IMDCT, respectively. The number of multiplications and additions needed to implement both of these two new methods are reduced substantially.

In one aspect, the invention describes a method performed by a computer for computing modified discrete cosine transfer comprising the steps of:

$$computing x ( k ) = \{ \begin{matrix}[ - y ( 26 - k ) - y ( 27 + k ) ] \cdot {b}_{k} & for 0 \leq k \leq 8 \\ [ y ( k - 9 ) - y ( 26 - k ) ] \cdot {b}_{k} & for 9 \leq k \leq 17\end{matrix} . ; \\ computing {Y}^{′} ( n ) = {\sum }_{k = 0}^{17} x ( k ) cos [ \frac{π}{36} ( 2 k + 1 ) n ] for 0 \leq n \leq 17 ; \\ defining Y ( 0 ) = {Y}^{′} ( 0 ) / 2 ; and computing Y ( n ) = {Y}^{′} ( n ) - Y ( n - 1 ) for 1 \leq n \leq 17.$$

In another aspect, the invention describes an MPEG encoder/decoder comprising:

$$means for computing x ( k ) = \{ \begin{matrix}[ - y ( 26 - k ) - y ( 27 + k ) ] \cdot {b}_{k} & for 0 \leq k \leq 8 \\ [ y ( k - 9 ) - y ( 26 - k ) ] \cdot {b}_{k} & for 9 \leq k \leq 17\end{matrix} . ; \\ means for computing {Y}^{′} ( n ) = {\sum }_{k = 0}^{17} x ( k ) cos [ \frac{π}{36} ( 2 k + 1 ) n ] for 0 \leq n \leq 17 ; \\ means for defining Y ( 0 ) = {Y}^{′} ( 0 ) / 2 ; and means for computing Y ( n ) = {Y}^{′} ( n ) - Y ( n - 1 ) for 1 \leq n \leq 17.$$

The encoder/decoder may also comprise of: means for computing Y′(k)=Y(k)·bₖ for 0≦k≦17;

$$means for computing {y}^{′′′} ( n ) = {\sum }_{k = 0}^{17} {Y}^{′} ( k ) cos [ \frac{π}{2 * 18} ( 2 k + 1 ) n ] for 0 \leq n \leq 17 ;$$

$$means for computing {y}^{′} ( n ) = \{ \begin{matrix}{y}^{′′′} ( n + 9 ) & for 0 \leq n \leq 8 \\ 0 & for n = 9 \\ - {y}^{′′′} ( 27 - n ) & for 10 \leq n \leq 26 \\ - {y}^{′′′} ( n - 27 ) & for 27 \leq n \leq 35\end{matrix} ; \\ means for defining y ( 0 ) = {\sum }_{k = 0}^{18 - 1} Y ( k ) \cdot {c}_{k} ; and means for computing y ( n ) = {y}^{′} ( n ) - y ( n - 1 ) for 1 \leq n \leq 35.$$

### BRIEF DESCRIPTION OF THE DRAWINGS

The objects, advantages and features of this invention will become more apparent from a consideration of the following detailed description and the drawings, in which:

FIG. 1 is an exemplary hardware butterfly diagram for a fast 18-18 DCT method;

FIG. 2 is an exemplary hardware butterfly diagram for a fast 36-18 MDCT method; and

FIG. 3 is an exemplary hardware butterfly diagram for fast 18-36 IMDCT described.

### DEATILED DESCRIPTION

The system and method of the present invention computes the MDCT and its IMDCT, respectively with a substantially reduced number of multiplications and additions. Additionally, a computer simulation shows that the speed of these two new methods for computing the MDCT and IMDCT are 7.2 times and 4.3 times faster than the direct methods, respectively. The present invention significantly improves the performance and effectiveness of data compression methods such as, MP III, MPEG, and other audio/video compression methods. By this means, the MDCT or IMDCT defined in Hwang-Cheng Chiang and Jie-Cherng Liu, “Regressive Implementation for the Forward and Inverse MDCT in MPEG Audio Coding,” IEEE Signal Processing Letters, vol.3, no.4, pp.116-117, April 1996 [10], the contents of which are hereby incorporated by reference, can be converted first into the standard DCT of length N=18. Then such an 18-point DCT can be implemented by using the same length Winograd's DFT method.

The advantage of this new method over the previous methods is that the 18-point DCT can be used to compute both the MDCT and IMDCT simultaneously. As a consequence, the computation of the 18-point IDCT needed to perform the MDCT method developed in Hsieh S. Hou, “A Fast Recursive Method for Computing the Discrete Cosine Transform,” IEEE Trans on Acoustics, Speech and Signal processing, vol. ASSP-35, no. 10, pp. 1455-1461, October 1987 [9], the contents of which are hereby incorporated by reference, is completely avoided in this new MDCT method. With these new techniques, the new MDCT and IMDCT methods require only a small fraction of the number of multiplications and additions that are required in direct methods, respectively.

Fast Method for Computing the 18-point DCT

Let x(k) be a sequence with length N=18. The DCT of x(k) defined in [3] is given by

$$X ( n ) = {\sum }_{k = 0}^{18 - 1} x ( k ) cos \frac{π}{36} ( 2 k + 1 ) n for 0 \leq n \leq 17 \qquad ( 1 )$$

In (1), X(n) can be decomposed into the even and odd indexed output of the DCT. That is,

A(n)=X(2n) for 0≦n≦8 (2)

B(n)=X(2n+1) for 0≦n≦8 (3)

By [3], (2) and (3) can be shown to be two DCT's with length 9 as fellows:

$$\begin{matrix}A ( n ) = {\sum }_{k = 0}^{9 - 1} a ( k ) cos [ \frac{π}{2 \times 9} ( 2 k + 1 ) n ] for 0 \leq n \leq 8 \\ where & ( 4 ) \\ a ( k ) = x ( k ) + x ( 18 - 1 - k ) \\ and & ( 5 ) \\ {B}^{′} ( n ) = {\sum }_{k = 0}^{9 - 1} b ( k ) cos [ \frac{π}{2 \times 9} ( 2 k + 1 ) n ] for 0 \leq n \leq 8 \\ where & ( 6 ) \\ b ( k ) = 2 [ x ( k ) - x ( 18 - 1 - k ) ] cos [ \frac{π}{2 \times 18} ( 2 k + 1 ) ] & ( 7 ) \\ {B}^{′} ( n ) = B ( n ) + B ( n - 1 ) for 0 \leq n \leq 8 \\ Note that B ( 0 ) = B ( - 1 ) . From ( 8 ) , one obtains & ( 8 ) \\ B ( 0 ) = \frac{{B}^{′} ( 0 )}{2} & ( 9 )\end{matrix}$$

Using the sequence B′(n) obtained by (6), B(n) for 0≦n≦8 can be obtained by the use of both (9) and the recursive form in (8).

Since A(n) in (4) is a 9-point DCT, then, it is shown in [5] that this DCT can be computed by the use of the identical-length DFT method developed by Winograd [5,6]. To illustrate this, first, the decomposition of (4) into two even and odd values of n of the DCI appears as follows:

$$\begin{matrix}A ( 2 n ) = {\sum }_{k = 0}^{9 - 1} a ( k ) cos [ \frac{π}{2 \times 9} ( 2 k + 1 ) 2 n ] for 0 \leq n \leq 4 \\ and & ( 10 ) \\ A ( 9 - 2 n ) = {\sum }_{k = 0}^{9 - 1} a ( k ) cos [ \frac{π}{2 \times 9} ( 2 k + 1 ) ( 9 - 2 n ) ] for 0 \leq n \leq 4 & ( 11 )\end{matrix}$$

It follows from [4] that (10) and (11) can be shown to the following:

$$A ( 2 n ) = {( - 1 )}^{″} Re \{ {\sum }_{k = 0}^{9 - 1} {a}^{′} ( k ) {ω}^{nk} \} ( 12 )$$

$$and$$

$$A ( 9 - 2 n ) = {( - 1 )}^{n + 1} Im \{ {\sum }_{k = 0}^{9 - 1} {a}^{′} ( k ) {ω}^{nk} \} ( 13 )$$

$$where ω = {ⅇ}^{\frac{i2π}{9}} is the {9}^{th} root of unity and {a}^{′} ( k ) is defined by$$

$${a}^{′} ( k ) = \{ \begin{matrix}a ( {( - 1 )}^{k + 6} k + 4 ) & for 0 \leq k \leq 4 & ( 14 ) \\ a ( {( - 1 )}^{k + 6} ( 9 - k ) + 4 ) & for 5 \leq k \leq 8 & ( 15 )\end{matrix} \\ Define the 9 \text{-} point DFT as follows \text{:} \\ \begin{matrix}{A}^{′} ( n ) = {\sum }_{k = 0}^{9 - 1} {a}^{′} ( k ) {ω}^{nk} & ( 16 )\end{matrix}$$

It is shown in [4] that the transform in (16) can be computed with a minimum number of operations by Winograd's method. The substitution of (16) into (14) and (13) yields

A(2n)=(−1)″Re{A′(n)} for 0≦n>4 (17)

A(9−2n)−(−1)ⁿ⁺¹^{Im{A′}(n)} for 5≦n≦8 (18)

where A′(n) is given in (16).

The detailed method given in [5] for computing the 9-point DCT in (4) is given in Appendix A. One observes from this method that the number of multiplications and additions are 10 and 34, respectively. In a similar fashion, by replacing a(k) and A(n) by b(k) and B′(n) respectively, (6) can also be computed by the use of the method given in Appendix A.

Let x(k) be a sequence of length 18. The fast method for computing the 18-point DCI defined in (1) comprises the following three steps:

(1). Compute a(k) and b(k) from (5) and (7). That is,

$$\begin{matrix}a ( k ) = x ( k ) + x ( 18 - 1 - k ) for 0 \leq k \leq 8 \\ b ( k ) = 2 ( x ( k ) - x ( 18 - 1 - k ) ) cos [ \frac{π}{36} ( 2 k + 1 ) ] for 0 \leq k \leq 8.\end{matrix}$$

(2). Use the fast method given in Appendix A to compute the 9-point DCT of a(k), i.e. A(n) in (4) and the 9-point DCT of b(k), i.e., B′(n) in (6) for 0≦n≦8.

(3). Use both the recursive formulae for 1≦n≦8 in (8) and (9) to compute B(n) from the known B′(n) for 0≦n≦8. That is, B(0)=B′(0)/2, and B(n)=B′(n)−B(n−1) for 1≦n≦8. Then set X(2n)=A(n), for 0≦n≦8 And X(2n+1)=B(n) for 0≦n≦8, where X(n) is a 18-point DCT of x(k) given in (1).

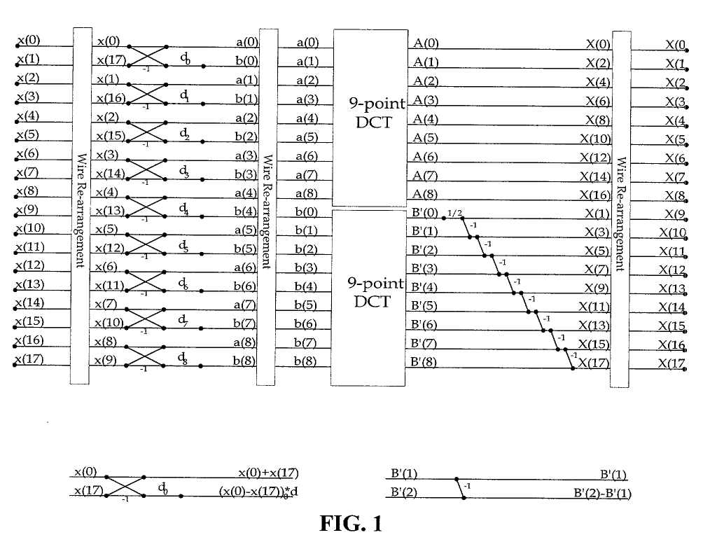

From the method described above, it can be shown that the total number of multiplications and additions needed to compute (1) are 29 and 97, respectively. In contrast, 324 multiplications and 306 additions are required for a direct computation of (1). An exemplary butterfly diagram of a fast 18-18 DCT is depicted in FIG. 1. FIG. 1 shows an exemplary hardware butterfly diagram for the fast 18-18 DCT method. The button diagrams indicate the computation flows. The pre-computed constants are

$${d}_{k} = 2 cos [ \frac{π}{36} ( 2 k + 1 ) ] for 0 \leq k \leq 8.$$

Fast method for Computing the MDCT

Let y(k) be a sequence of length N=36, the MDCT of y(k) defined in [10] is given by

$$Y ( n ) = {\sum }_{k = 0}^{36 - 1} y ( k ) cos [ \frac{π}{2 * 36} ( 2 k + 1 + 18 ) ( 2 n + 1 ) ] for 0 \leq n \leq 17 \qquad ( 19 )$$

Instead of computing (19), an alternating technique is employed. To see this, replacing k by 36−1−k in (19), one obtains

$$\begin{matrix}Y ( n ) = {\sum }_{k = 0}^{35} y ( 36 - 1 - k ) cos [ \frac{π}{2 * 36} ( ( 2 * 36 ) ( 2 n + 1 ) - ( 2 k + 1 - 18 ) ( 2 n + 1 ) ) ] \\ But \\ cos [ \frac{π}{2 * 36} ( ( 2 * 36 ( 2 n + 1 ) - ( 2 k + 1 - 18 ) ( 2 n + 1 ) ) ] = - cos [ \frac{π}{2 * 36} ( 2 k + 1 - 18 ) ( 2 n + 1 ) ] \\ Thus , ( 19 ) becomes & ( 20 ) \\ Y ( n ) = - {\sum }_{k = 0}^{35} y ( 36 - 1 - k ) cos [ \frac{π}{2 * 36} ( 2 k + 1 - 18 ) ( 2 n + 1 ) ] for 0 \leq n \leq 17 \\ If & ( 21 ) \\ {Y}^{′} ( n ) = Y ( n ) + Y ( n - 1 ) for 0 \leq n \leq 17 \\ then & ( 22 ) \\ ' ( n ) = {\sum }_{k = 0}^{35} {y}^{′} ( k ) cos [ \frac{π}{2 * 36} ( 2 k + 1 - 18 ) ( 2 n ) ] \\ where & \text{(23a)} \\ {y}^{′} ( k ) = - 2 y ( 36 - 1 - k ) cos [ \frac{π}{2 * 36} ( 2 k + 1 - 18 ) ] for 0 \leq k \leq 35 & \text{(23b)}\end{matrix}$$

The substitution of (21) into (22) yields,

$$\begin{matrix}{Y}^{′} ( n ) = - {\sum }_{k = 0}^{36 - 1} y ( 36 - 1 - k ) cos [ \frac{π}{2 * 36} ( 2 k + 1 - 18 ) ( 2 n + 1 ) ] - {\sum }_{k = 0}^{36 - 1} y ( 36 - 1 - k ) cos [ \frac{π}{2 * 36} ( 2 k + 1 - 18 ) ( 2 n - 1 ) ] \\ = - {\sum }_{k = 0}^{35} y ( 36 - 1 - k ) cos [ \frac{π}{2 * 36} ( ( 2 k + 1 - 18 ) ( 2 n ) + ( 2 k + 1 - 18 ) ) ] - {\sum }_{k = 0}^{35} y ( 36 - 1 - k ) cos [ \frac{π}{2 * 36} ( ( 2 k + 1 - 18 ) ( 2 n ) - ( 2 k + 1 - 18 ) ) ] \\ ( 24 ) can be shown as & ( 24 ) \\ {Y}^{′} ( n ) = - {\sum }_{k = 0}^{35} 2 y ( 36 - 1 - k ) cos [ \frac{π}{2 * 36} ( 2 k + 1 - 18 ) ] cos [ \frac{π}{2 * 36} ( 2 k + 1 - 18 ) ( 2 n ) ] \\ = {\sum }_{k = 0}^{35} {y}^{′} ( k ) cos [ \frac{π}{36} ( 2 k + 1 - 18 ) n ] & ( 25 )\end{matrix}$$

where y′(k) is given in (23b).

From (21), one observes that Y(0)=Y(−1). Using this result and the recursive formula in (22), one yields

Y(0)=Y′(0)/2 (26a)

Y(n)=Y′(n)−Y(n−1) for 1≦n≦17 (26b)

Using the sequence y′(n) obtained by (25b), the sequence y(n) for 0≦n≦17 can be obtained by the use of (26a) and (26b). Let

$${y}^{″} ( k ) = \{ \begin{matrix}{y}^{′} ( k + 9 ) for 0 \leq k \leq 26 & \text{(27a)} \\ {y}^{′} ( k - 27 ) for 27 \leq k \leq 35 & \text{(27b)}\end{matrix} \\ Then \\ {Y}^{′} ( n ) = {\sum }_{k = 0}^{35} {y}^{″} ( k ) cos [ \frac{π}{36} ( 2 k + 1 ) n ] ( 28 )$$

The proof of this is similar to that used in Lemma I in [7]. To prove this, (25) can be rewritten as:

$$\begin{matrix}{Y}^{′} ( k ) = {\sum }_{k = 0}^{8} {y}^{′} ( k ) cos [ \frac{π}{36} ( 2 k + 1 - 18 ) n ] + {\sum }_{k = 9}^{35} {y}^{′} ( k ) cos [ \frac{π}{36} ( 2 k + 1 - 18 ) n ] \\ Let k = {k}^{′} + 9 , ( 29 ) becomes & ( 29 ) \\ {Y}^{′} ( n ) = {\sum }_{{k}^{′} = - 9}^{- 1} {y}^{′} ( {k}^{′} + 9 ) cos [ \frac{π}{36} ( 2 {k}^{′} + 1 ) n ] + {\sum }_{k = 0}^{26} {y}^{′} ( {k}^{′} + 9 ) cos [ \frac{π}{36} ( 2 {k}^{′} + 1 ) n ] & ( 30 )\end{matrix}$$

Also, let k′+9=k−27 in the first summation and let k′=k in the second summation of (30). Then

$$\begin{matrix}{Y}^{′} ( n ) = {\sum }_{k = 27}^{35} {y}^{′} ( k - 27 ) cos [ \frac{π}{36} ( ( 2 k + 1 ) n - ( 2 \times 36 ) n ) ] + {\sum }_{k = 0}^{26} {y}^{′} ( k + 9 ) cos [ \frac{π}{36} ( 2 k + 1 ) n ] \\ But \\ cos [ \frac{π}{36} ( ( 2 k + 1 ) n - ( 2 \times 36 ) n ) ] = cos [ \frac{π}{36} ( 2 k + 1 ) n ] \\ Thus , ( 31 ) becomes & ( 31 ) \\ {Y}^{′} ( n ) = {\sum }_{k = 0}^{35} {y}^{″} ( n ) cos [ \frac{π}{36} ( 2 k + 1 ) n ] & ( 32 )\end{matrix}$$

where y′(k) is given in (27a) and (27b).

For given y″(k) as defined in (27a) and (27b),

$$X ( n ) = {Y}^{′} ( n ) = {\sum }_{k = 0}^{17} x ( k ) cos [ \frac{π}{36} ( 2 k + 1 ) n ] for 0 \leq n \leq 17 \qquad ( 33 )$$

where

x(k)=y″(k)+y(36−1−k) for 0≦k≦1 (34)

The proof of this is also similar to that used in Lemma 2 in [7]. To see this, (32) can be rewritten as

Y′(n)=Y₁′(n)+Y₂′(n) for 0≦n≦1 (35)

where

$$\begin{matrix}{Y}_{1}^{′} ( n ) = {\sum }_{k = 0}^{17} {y}^{″} ( k ) cos [ \frac{π}{36} ( 2 k + 1 ) n ] \\ and & ( 36 ) \\ {Y}_{2}^{′} ( n ) = {\sum }_{k = 18}^{35} {y}^{″} ( k ) cos [ \frac{π}{36} ( 2 k + 1 ) n ] & ( 37 )\end{matrix}$$

Let k=36−1−k′. Then Y₂′(n) in (37) becomes

$${Y}_{2}^{′} ( n ) = {\sum }_{{k}^{′} = 17}^{0} {y}^{″} ( 36 - 1 - {k}^{′} ) cos [ \frac{π}{36} ( 2 ( 36 - 1 - {k}^{′} ) + 1 ) n ] \\ However , \\ cos \frac{π}{36} ( 2 \times 36 n - ( 2 {k}^{′} + 1 ) n ) = cos \frac{π}{36} ( 2 {k}^{′} + 1 ) n \qquad ( 38 )$$

Hence, let k′=k, (38) becomes

$${Y}_{2}^{′} ( n ) = {\sum }_{{k}^{′} = 0}^{17} {y}^{″} ( 36 - 1 - {k}^{′} ) cos \frac{π}{36} ( 2 {k}^{′} + 1 ) n \qquad ( 39 )$$

The substitution (39) and (36) into (35) yields

$$\begin{matrix}' ( n ) = {\sum }_{k = 0}^{17} {y}^{″} ( k ) cos [ \frac{π}{36} ( 2 k + 1 ) n ] + {\sum }_{k = 0}^{17} {y}^{″} ( 36 - 1 - k ) cos [ \frac{π}{36} ( 2 k + 1 ) n ] \\ = {\sum }_{k = 0}^{17} x ( k ) cos [ \frac{π}{36} ( 2 k + 1 ) n ] for 0 \leq n \leq 17\end{matrix} \qquad ( 40 )$$

where x(k) is given in (33). From the above, it can be seen that (33) is an 18-point DCT which can be efficiently computed by the use of the fast method given in the previous section.

Suppose that y(k) is a sequence of length N=36. For 0≦k≦8, one has 27≦36−1−k≦35. Thus, from (27) and (23b), (34) becomes

$$\begin{matrix}x ( k ) = {y}^{″} ( k ) + {y}^{″} ( 36 - 1 - k ) \\ = {y}^{′} ( k + 9 ) + {y}^{′} ( 8 - k ) \\ = - 2 y ( 26 - k ) cos [ \frac{π}{2 \times 36} ( 2 k + 1 ) ] - 2 y ( 27 + k ) cos [ \frac{π}{2 \times 36} ( 2 k + 1 ) ] \\ = [ - y ( 26 - k ) - y ( 27 + k ) ] \cdot 2 cos [ \frac{π}{2 \times 36} ( 2 k + 1 ) ]\end{matrix}$$

Similar, for 9≦k≦17, (34) becomes

$$\begin{matrix}x ( k ) = {y}^{′} ( k + 9 ) + {y}^{′} ( 44 - k ) \\ = - 2 y ( 26 - k ) cos [ \frac{π}{2 \times 36} ( 2 k + 1 ) ] - 2 y ( k - 9 ) cos [ \frac{π}{2 \times 36} ( 71 - 2 k ) ] \\ = [ y ( k - 9 ) - y ( 26 - k ) ] \cdot 2 cos [ \frac{π}{72} ( 2 k + 1 ) ]\end{matrix}$$

$$since cos [ \frac{π}{2 \times 36} ( 71 - 2 k ) ] = - cos [ \frac{π}{2 \times 36} ( 2 k + 1 ) ] .$$

$$Let {b}_{k} = 2 cos [ \frac{π}{2 \times 36} ( 2 k + 1 ) ]$$

be the pre-computed constants. The fast method for computing the MDCT of y(k) in (19) is composed of the following three successive steps of computation:

(1). Compute

$$x ( k ) = \{ \begin{matrix}[ - y ( 26 - k ) - y ( 27 + k ) ] \cdot {b}_{k} & for 0 \leq k \leq 8 \\ [ y ( k - 9 ) - y ( 26 - k ) ] \cdot {b}_{k} & for 9 \leq k \leq 17\end{matrix} .$$

(2). Use the fast method described in Section II to compute the 18-point DCT of x(k), i.e., Y′(n) defined in (40). That is,

$${Y}^{′} ( n ) = {\sum }_{k = 0}^{17} x ( k ) cos [ \frac{π}{36} ( 2 k + 1 ) n ]$$

for

0≦n≦17

(3). Let Y(0)=Y′(0)/2.

Then compute Y(n)=Y′(n)−Y(n−1) for 1≦n≦17.

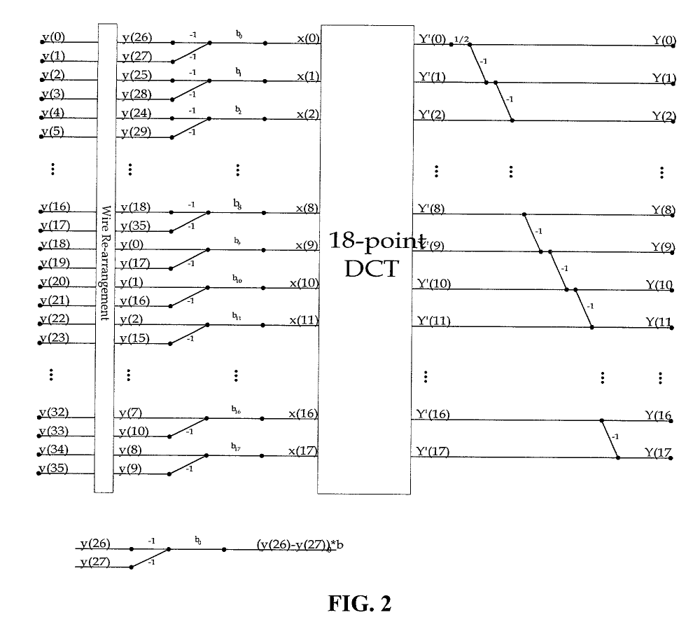

This new method is simpler and faster than that of the brute-force method. The number of multiplications and additions needed for this method and the brute-force method is given in Table 1. Table 1 shows that the multiplications and additions needed to implement this new method require only 10.03% and 20.95% of the brute-force method, respectively. The butterfly diagram of the fast 36-18 MDCT is depicted in FIG. 2. FIG. 2 illustrates an exemplary hardware butterfly diagram for the above fast 36-18 MDCT method. The button diagram indicates the computation flow. The pre-computed constants are

$${b}_{k} = 2 cos [ \frac{π}{2 \times 36} ( 2 k + 1 ) ] .$$

Fast Method for Computing the IMDCT

Let Y(k) for 0≦k≦17 be the output sequence of (19). The inverse MDCT of Y(k) defined in [10] is given by

$$y ( n ) = {\sum }_{k = 0}^{18 - 1} Y ( k ) cos [ \frac{π}{2 * 36} ( 2 n + 1 + 18 ) ( 2 k + 1 ) ] for 0 \leq n \leq 35 \qquad ( 41 )$$

If y′(n)=y(n)+y(n−1), using a proof similar to that used in (24)-(26), then (41) can be expressed by

$$\begin{matrix}{y}^{′} ( n ) = {\sum }_{k = 0}^{18 - 1} {Y}^{′} ( k ) cos [ \frac{π}{2 * 36} ( 2 n + 18 ) ( 2 k + 1 ) ] for 0 \leq n \leq 35 \\ where & ( 42 ) \\ {Y}^{′} ( k ) = 2 Y ( k ) cos [ \frac{π}{2 * 36} ( 2 k + 1 ) ] for 0 \leq k \leq 17 & ( 43 )\end{matrix}$$

It follows from (41) that

$$y ( 0 ) = {\sum }_{k = 0}^{18 - 1} Y ( k ) cos [ \frac{π}{2 * 36} ( 19 ) ( 2 k + 1 ) ] \qquad ( 44 )$$

Using the sequence y′(n) obtained by (42), again, y(n) can be obtained by the use of the initial condition y(0) given in (44) and the recursive formula y(n)=y′(n)−y(n−1) for 1≦n≦35.

Define

$${y}^{″} ( n ) = \{ \begin{matrix}{y}^{′} ( n - 9 ) & for 9 \leq n \leq 35 & ( 45 ) \\ {y}^{′} ( n + 27 ) & for 0 \leq n \leq 8 & ( 46 )\end{matrix}$$

From (42), (45) and (46) can be shown to the following

$$\begin{matrix}{y}^{″} ( n ) = {y}^{′} ( n - 9 ) = {\sum }_{k = 0}^{18 - 1} {Y}^{′} ( k ) cos [ \frac{π}{2 * 36} ( 2 k + 1 ) 2 n ] for 9 \leq n \leq 35 & ( 47 ) \\ {y}^{″} ( n ) = {y}^{′} ( n + 27 ) = {\sum }_{k = 0}^{18 - 1} {Y}^{′} ( k ) cos [ \frac{π}{2 * 36} ( 2 n + 72 ) ( 2 k + 1 ) ] for 0 \leq n \leq 8 & ( 48 )\end{matrix}$$

In (47), it is can be shown that y″ (18)=0. Based on [7], the following can be proved: In (47) and (48),

y″(18+j)=−y″(18−j) for 1<j≦9 (49)

y″(18+j)=y″(18−j) for 10≦j≦17 (50)

Thus, for 1≦j≦9, from (47), one has

$$\begin{matrix}{y}^{″} ( 18 + j ) = {\sum }_{k = 0}^{18 - 1} {Y}^{′} ( k ) cos [ \frac{π}{2 * 36} \cdot 2 ( 18 + j ) ( 2 k + 1 ) ] \\ = {\sum }_{k = 0}^{18 - 1} {Y}^{′} ( k ) cos [ \frac{π}{2 * 36} ( 2 * 18 ) ( 2 k + 1 ) + \frac{π}{4 * 18} ( 2 j ) ( 2 k + 1 ) ] \end{matrix} \qquad ( 51 )$$

Using cos(A+B)=cos A·cos B−sin·A sin B,

$$\begin{matrix}{y}^{″} ( 18 + j ) = - {\sum }_{k = 0}^{18 - 1} {Y}^{′} ( k ) sin [ \frac{π}{2} ( 2 k + 1 ) ] \cdot sin [ \frac{π j}{2 * 18} ( 2 k + 1 ) ] for 1 \leq j \leq 9 \\ Similarly , & ( 52 ) \\ \begin{matrix}{y}^{″} ( 18 - j ) = {\sum }_{k = 0}^{18 - 1} {Y}^{′} ( k ) cos [ \frac{π}{4 * 18} 2 ( 18 - j ) ( 2 k + 1 ) ] \\ = {\sum }_{k = 0}^{18 - 1} {Y}^{′} ( k ) sin [ \frac{π}{2} ( 2 k + 1 ) ] \cdot sin [ \frac{π j}{2 * 18} ( 2 k + 1 ) ] for 1 \leq j \leq 9\end{matrix} & ( 53 )\end{matrix}$$

From (52) and (53), y″(18+j) =−y″(18−j) for 1≦j≦9.

For 10≦j≦17, from (48), one has

$$\begin{matrix}{y}^{″} ( 18 - j ) = {\sum }_{k = 0}^{17} {Y}^{′} ( k ) cos [ \frac{π}{2 * 36} ( 2 ( 18 - j ) + 72 ) ( 2 k + 1 ) ] \\ = {\sum }_{k = 0}^{17} {Y}^{′} ( k ) cos [ \frac{108 π}{2 * 36} ( 2 k + 1 ) - \frac{π j}{2 * 18} ( 2 k + 1 ) ]\end{matrix} \qquad ( 54 )$$

Again, using cost(A−B)=cos A·cos B+sin A·sin B, (54) becomes

$${y}^{″} ( 18 - j ) = {\sum }_{k = 0}^{17} {Y}^{′} ( k ) sin [ \frac{3 π}{2} ( 2 k + 1 ) \cdot sin \frac{π j}{2 * 18} ( 2 k + 1 ) ] \qquad ( 55 )$$

However,

$$sin \frac{3 π}{2} ( 2 k + 1 ) = - sin \frac{π}{2} ( 2 k + 1 ) .$$

Hence, (55) becomes

$${y}^{″} ( 18 - j ) = - {\sum }_{k = 0}^{17} {Y}^{′} ( k ) sin [ \frac{π}{2} ( 2 k + 1 ) ] \cdot sin [ \frac{π j}{2 * 18} ( 2 k + 1 ) ] \qquad ( 56 )$$

From (52) and (54), y″(18+j)=−y″(18−j) for 10≦j≦17.

It follows from the above proof that one only computes y″(n) for 0≦n≦17. In other words, for given y″(n), where 0≦n≦17, y″(n) for 19≦n≦35 can be obtained from using (49) and (50). Recall that y″(18)=0.

Also, by defining

| | | |
|---|---|---|
| y′′′ (n) = −y″ (n) | for 0 ≦ j ≦ 8 | (57) |
| y′′′ (n) = y″ (n) | for 9 ≦ j ≦ 17 | (58) |

Then

$${y}^{′′′} ( n ) = {\sum }_{k = 0}^{17} {Y}^{′} ( k ) cos [ \frac{π}{2 * 18} ( 2 k + 1 ) n ] for 0 \leq n \leq 17 \qquad ( 59 )$$

As a result, for 0≦n≦8, from (48), one yields

$$\begin{matrix}{y}^{″} ( n ) = {\sum }_{k = 0}^{17} {Y}^{′} ( k ) cos [ \frac{π}{2 * 18} n ( 2 k + 1 ) + π ( 2 k + 1 ) ] \\ = - {\sum }_{k = 0}^{17} {Y}^{′} ( k ) cos [ \frac{π}{2 * 18} ( 2 k + 1 ) n ] \\ = - {y}^{′′′} ( x )\end{matrix}$$

For 9≦n≦17, from (47), one obtains y′″(n)=y″(n).

In (59), y′″(n) is an 18-point DCT. By replacing y′″(n) and Y′(k) by X(n) and x(k), respectively, the 18-point DCT in (59) is the same as (1). As a consequence, the fast method developed in Section II can also be used to compute (59).

From (45) and (46), one has

$${y}^{′} ( n ) = \{ \begin{matrix}{y}^{″} ( n + 9 ) & for 0 \leq n \leq 26 \\ {y}^{″} ( n - 27 ) & for 27 \leq n \leq 35\end{matrix}$$

Together with (49), (50), (57) and (58), y′(n) can be expressed in terms of y′″(n) as follows:

y′(n)=y′(n+9)=y′″(n+9) for 0≦n≦8

y′(n)=y″(n+9)=y″(18)=0 for n=9

$$\begin{matrix}{y}^{′} ( n ) = {y}^{″} ( n + 9 ) \\ = {y}^{″} ( 18 + ( n - 9 ) ) \\ = - {y}^{″} ( 18 - ( n - 9 ) ) for 10 \leq n \leq 18 \\ = - {y}^{″} ( 27 - n ) \\ = - {y}^{′′′} ( 27 - n )\end{matrix}$$

y′(n)=−y′(27−n) for 19≦n≦26

y′(n)=−y′″(n−27) for 27≦n≦35

Let Y(k) for 0≦k≦17 be the output sequence of (19). Also let

$${b}_{k} = 2 cos [ \frac{π}{2 \times 36} ( 2 k + 1 ) ]$$

be the pre-computed constants which are the same as those defined in the MDCT method in the previous section. Finally, let

$${c}_{k} = cos [ \frac{19 π}{2 \times 36} ( 2 k + 1 ) ] .$$

The fast method for computing (41) is comprised of the following 4 steps of computation:

(1). Compute

Y′(k)=Y(k)·bₖ for 0≦k≦17

(2). Use the fast method described in Section II to compute the 18-point DCT of Y(k) given in (59). That is,

$${y}^{′′′} ( n ) = {\sum }_{k = 0}^{17} {Y}^{′} ( k ) cos [ \frac{π}{2 * 18} ( 2 k + 1 ) n ] for 0 \leq n \leq 17$$

(3). Compute

$${y}^{′} ( n ) = \{ \begin{matrix}{y}^{′′′} ( n + 9 ) & for & 0 \leq n \leq 8 \\ 0 & for & n = 9 \\ - {y}^{′′′} ( 27 - n ) & for & 10 \leq n \leq 26 \\ - {y}^{′′′} ( n - 27 ) & for & 27 \leq n \leq 35\end{matrix} \\ ( 4 ) . Let y ( 0 ) = {\sum }_{k = 0}^{18 - 1} Y ( k ) \cdot {c}_{k} .$$

Then compute y(n)=y′(n)−y(n−1) for 1≦n≦35.

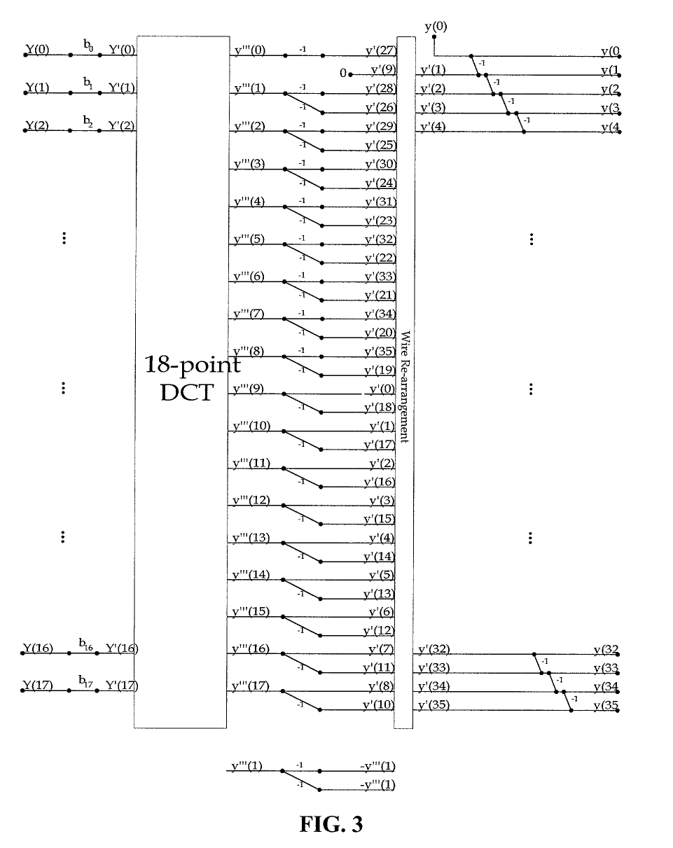

It is easy to observe that this new method for computing the IMDCT is simpler and faster than that of the brute-force method. The number of multiplications and additions needed for this fast method and the brute-force method is given Table 1. Table 1 shows that the number of multiplications and additions required to implement this new method are only 7.25% and 10.03%, respectively, of the brute-force method. The butterfly diagram of the fast 18-36 IMDCT is depicted in FIG. 3.

Program Implementation and Simulation Results

The MDCT and its IMDCT methods described above can be computed simultaneously by using the 18-point DCT. These two new methods are implemented using C++ language run on a Pentium 133/Windows 98 platform, in which the multiplications and additions are implemented using double data type. An example of the source code is given in Appendix B. The fast methods are verified by comparing their results of 10⁶ computations to those of the bruit-force methods. The computation times are provided in Table 1, which is in millisecond averaged from 10⁶ computations. These new methods for computing the MDCT and IMDCT require 0.0218 ms and 0.0375 ms as compared to 0.1567 ms and 0.1616 ms required by the brute-force methods, respectively.

As a consequence, the new methods for computing the MDCT and IMDCT are 7.2 and 4.3 times faster than the brute-force methods, respectively. In addition to audio compression such as MP III method, the resulting improvement is also useful for video compression methods such as MPEG method.

Additionally, the method of the present invention may be implemented in a custom application-specific integrated circuits (ASICs), general-purpose programmable DSP using firmware to program the DSP devices, and customizable arrays such as programmable logic arrays (PLAs) and field-programmable arrays (FPAs). Because the present invention uses the same encoding and decoding (recording and playback), the complexity of software, firmware, and hardware is significantly reduced resulting in cost improvement and flexibility, in addition to speed improvement.

FIG. 3 is an exemplary hardware butterfly diagram for fast 18-36 IMDCT described. The button diagram indicates the computation flow. The pre-computed constants are

$${b}_{k} = 2 cos [ \frac{π}{2 \times 36} ( 2 k + 1 ) ] and$$

$$y ( 0 ) = {\sum }_{k = 0}^{18 - 1} Y ( k ) \cdot {c}_{k} where {c}_{k} = cos [ \frac{19 π}{2 \times 36} ( 2 k + 1 ) ] .$$

TABLE I
NUMBER OF MULTIPLICATIONS AND ADDITIONS NEEDED
TO IMPLEMENT THE MDCT AND IMDCT

| | MDCT | | | | IMDCT | | | |
|---|---|---|---|---|---|---|---|---|
| | Step | Step | Step | | Step | Step | Step | |
| | 1 | 2 | 3 | Total | 1 | 2 | 3,4 | Total |
| New Method | | | | | | | | |
| Multipliers | 18 | 29 | 0 | 47 | 18 | 29 | 18 | 65 |
| Adders | 18 | 94 | 17 | 129 | 0 | 94 | 35 | 129 |
| Brute-force | | | | | | | | |
| method | | | | | | | | |
| Multipliers | | | | 648 | | | | 648 |
| Adders | | | | 630 | | | | 612 |

TABLE II
MDCT AND IMDCT EXECUTION TIMES IN MILLI SECOND

| | MDCT | IMDCT |
|---|---|---|
| New method | 0.0218 | 0.0375 |
| Brute-force methods | 0.1567 | 0.1616 |

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the claims in the area of signal processing of audio and video signals including compression of audio and video signals.

Appendix A:

This appendix contains the method developed in [5] for computing the 9-point DCT given by

$$A ( n ) = {\sum }_{k = 0}^{9 - 1} a ( k ) cos [ \frac{π}{2 \times 9} ( 2 k + 1 ) n ] for 0 \leq n \leq 8$$

Method for the 9-point DCT:

c₁=−0.866025, c₂=0.939693, c₃=−0.173648, c₄=−0.766044

c₅=0.5, c₆=−0.342020, c₇=−0.984808, c₈=−0.642788

d₁=a(3)+a(5), d₂=a(3)−a(5), d₃=a(6)+a(2), d₄=a(6)−a(2)

d₅=a(1)+a(7), d₆=a(1)−a(7), d₇=a(8)+a(0), d₈=a(8)−a(0)

d₉=a(4)+d₅, d₁₀=d₁+d₃, d₁₁=d₁₀+d₇, d₁₂=d₃−d₇,d₁₃=d₁—d₇, d₁₄=d₁−d₃

d₁₅=d₂−d₄, d₁₆=d₁₅+d₈, d₁₇=d₄+d₈, d₁₈=d₂−d₈, d₁₉=d₂+d₄

m₁=c₁d₆, m₂=c₅d₅, m₃=c₅, d₁₁, m₄=c₂d₁₂, m₅=c₃d₁₃

m₆=c₄d₁₄, m₇=c₁d₁₆, m₈=c₆d₁₇, m₉=c₇d₁₈, m₁₀=c₈d₁₉

d₂₀=a(4)−m₂, d₂₁=d₂₀+m₄, d₂₂=d₂₀−m₄, d₂₃=d₂₀+m₅

d₂₄=m₁+m₈, d₂₅=m₁−m₈, d₂₆=m₁+m₉

A₀=d₉+d₁₁, A₁=m₁₀−d₂₆, A₂=m₆−d₂₁, A₃=m₇, A₄=d₂₂−m₅

A₅=d₂₅−m₉, A₆=m₃−d₉, A₇=d₂₄+m₁₀, A₈=d₂₃+m₆

Thus, the 9-point DCT requires only 10 multiplications and 34 additions, respectively.

Appendix B: Source Code

Appendix B: Source Code

| //*************************************** | |
|---|---|
| // File name: mdct.cpp | |
| //*************************************** | |
| #include <iostream.h> | |
| #include <iomanip.h> | |
| #include <math.h> | |
| #include <time.h> | |
| #pragma hdrstop | |
| #include <condefs.h> | |
| #include “dct_lib.h” | |
| USEUNIT(“dct_lib.cpp”); | |
| //---------------------------------------------------------- | |
| int borg[100036]; | |
| double | |
| bin[100036],*ptbin,bout0[36],bout1[36]; | |
| //---------------------------------------------------------- | |
| #pragma argsused | |
| int main(int argc, char* argv[]) | |
| { | |
| int k,n; | |
| int i,cnt; | |
| double diff; | |
| clock_t ck1,ck2; | |
| cout<<“welcome to mdct test\n”; | |
| build_costab(); | |
| // the random data | |
| randomize(); | |
| for(k=0;k<100036;k++) | |
| borg[k]=random(255); | |
| for(k=0;k<100036;k++) | bin[k]=(double) |

borg[k];
// verify the MDCT and the fast methods
cnt=100000;
ptbin=bin;
cout<<“Verifying MDCT3618 and MDCT3618F,
cnt=“<<cnt<<end1<<end1;
for(i=0;i<cnt;i++)

{
MDCT3618 (ptbin,bout0);
MDCT3618F(ptbin,bout1);
ptbin++;
for(n=0;n<18;n++)

{

diff =((bout0[n]−

bout1[n])<.0000000001)?0:99999;

if(diff>0)

cout<<diff<<setw(10)<<bout0[n]<<setw(10)<
<bout1[n]<<“\n”;

}

}

// verify the IMDCT and the fast methods
ptbin=bin;
cout<<“Verifying IMDCT1836 and
IMDCT1836F, cnt=“<<cnt<<end1<<end1;
for(i=0;i<cnt;i++)

{
IMDCT1836 (ptbin,bout0);
IMDCT1836F(ptbin,bout1);
ptbin++;
for(n=0;n<36;n++)

{

diff=((bout0[n]−

bout1[n])<.0000000001)?0:99999;

if(diff>0)

cout<<diff<<setw(10)<<bout0[n]<<setw(10<<bout1[n])<<“\n”;

}

}

cnt=100000;
// computation time of MDCT3618
cout<<“Computation time of MDCT3618 : ”;
ptbin=bin;
ck1=clock();
for(i=0;i<cnt;i++)

```
  {
  MDCT3618 (ptbin,bout0);
  ptbin++;
}
```

ck2=clock();
cout<<setw(6)<<(ck2−ck1)<<end1;
// Computation time of MDCT3618F
cout<<“Computation time of MDCT3618F : ”;
ptbin=bin;
ck1=clock();
for(i=0;i<cnt;i++)

```
  {
  MDCT3618F(ptbin,bout1);
  ptbin++;
}
```

ck2=clock();
cout<<setw(6)<<(ck2−ck1)<<end1;
// Computation time of IMDCT1836
cout<<“Computation time of IMDCT1836 : ”;
pbtin=bin;
ck1=clock();
for(i=0;i<cnt;i++)

```
  {
  IMDCT1836 (ptbin,bout0);
  ptbin++;
}
```

ck2=clock();
cout<<setw(6)<<(ck2−ck1)<<end1;
// Computation time of IMDCT1836F
cout<<“Computation time of IMDCT1836F : ”;
pbtin=bin;
ck1=clock();
for(i=0;i<cnt;i++)

```
  {
  IMDCT1836F(ptbin,bout1);
  ptbin++;
}
```

ck2=clock();
cout<<setw(6)<<(ck2−ck1)<<end1<<end1;
return 0;
}
//***************************************
// File name: cdt_lib.cpp
//***************************************
#include <iostream.h>
#include <math.h>
#pragma hdrstop
#include “dct_lib.h”
//----------------------------------------------------------
#pragma package(smart_init)
// some pre-computed consine tables
double Cos99[9][9];
double Cos99W[9]; // used for DCT99W
double Cos1818[18][18];
double Cos1818F[18];// DCT1818F
double Cos3618[18][36]; // shared for
mdct3618, imdct1836
double Cos3618F[18];
double Cos1836F[18];
//=================================
// the COS table for various size
//=================================
void build_costab(void)
{
int n,k;
// DCT99
for(n=0;n<9;n++)

for(k=0;k<9;k++)
Cos99[n][k]=cos(M_PI/18*(2*k+1)*n);

// for DCT99W
Cos99W[1]=Cos99[1][7];
Cos99W[2]=Cos99[2][0];
Cos99W[3]=Cos99[2][2];
Cos99W[4]=Cos99[2][3];
Cos99W[5]=Cos99[2][1];
Cos99W[6]=Cos99[1][5];
Cos99W[7]=Cos99[1][8];
Cos99W[8]=Cos99[1][6];
// DCT1818
for(n=0;n<18;n++)

for (k=0;k<18;k++)
Cos1818[n][k]=cos(M_PI/36*(2*k+1)*n)

;
// DCT1818F
for(k=0;k<18;k++)

Cos1818F[k]=2*Cos1818[1][k];

// DCT3618
for(n=0;n<18;n++)

for(k=0;k<36;k++)
Cos3618[n][k]=cos(M_PI/72*(2*k+19)*(2*n+1));

// DCT3618F
for(k=0;k<18;k++)

Cos3618F[k]=2*cos(M_PI/72*(2*k+1));

// IMDCT1836F
for(k=0;k<18;k++)

Cos1836F[k]=cos(M_PI/72*19*(2*k+1));

}
//=================================
//=================================
// 9—9 DCT, standard
//=================================
void DCT99(double *a, double *A)
}
int n,k;
double s;
for(n=0;n<9;n++)

{

s=0;
for(k=0;k<9;k++)

{

s+=a[k]*Cos99[n][k];
}

A[n]=s;
}

}
//=================================
// 9—9 DCT, Winogard
//=================================
void DCT99W(double *a, double *A)
{
double d[64],m[64];
d[1]=a[3]+a[5];
d[2]=a[3]−a[5];
d[3]=a[6]+a[2];
d[4]=a[6]−a[2];
d[5]=a[1]+a[7];
d[6]=a[1]−a[7];
d[7]=a[8]+a[0];
d[8]=a[8]−a[0];
d[9]=a[4]+d[5];
d[10]=d[1]+d[3];
d[11]=d[10]+d[7];
d[12]=d[3]−d[7];
d[13]=d[1]−d[7];
d[14]=d[1]−d[3];
d[15]=d[2]−d[4];
d[16]=d[15]+d[8];
d[17]=d[4]+d[8];
d[18]=d[2]−d[8];
d[19]=d[2]+d[4];
m[1]=Cos99W[1]*d[6];
m[2]=Cos99W[5]*d[5];
m[3]=Cos99W[5]*d[11];
m[4]=Cos99W[2]*d[12];
m[5]=Cos99W[3]*d[13];
m[6]=Cos99W[4]*d[14];
m[7]=Cos99W[1]*d[16];
m[8]=Cos99W[6]*d[17];
m[9]=Cos99W[7]*d[18];
m[10]=Cos99W[8]*d[19];
D[20]=a[4]−m[2];
D[21]=d[20]+m[4];
D[22]=d[20]−m[4];
D[23]=d[20]+m[5];
d[24]=m[1]+m[8];
d[25]=m[1]−m[8];
d[26]=m[1]+m[9];
A[0]=d[9]+d[11];
A[1]=m[10]−d[26];
A[2]=m[6]−d[21];
A[3]=m[7];
A[4]=d[22]−m[5];
A[5]=d[25]−m[9];
A[6]=d[3]−d[9];
A[7]=d[24]+m[10];
A[8]=d[23]+m[6];
}
//=================================
//=================================
// 18—18 DCT, standard
//=================================
void DCT1818(double *a, double *A)
{
int n,k;
double s;
for(n=0;n<18;n++)

{

s=C;
for*k=0;k<18;k++)

{

s+=a[k]*Cos1818[n][k];
}

A[n]=s;
}

}
//=================================
//=================================
// 18—18 DCT, fast
//=================================
void DCT1818F(double *x, double *X)
}
int n,k:
double a[9],b[9],A[9],B[9],Bp[9];
for(k=0;k<9;k++)

{

a[k]=x[k]+x[18−1−k];
a[k]=(x[k]−x[18−1−k])*Cos1818F[k];
}

DCT99W(a,A);
DCT99W(b,Bp);
B[0]=Bp[0]/2;
for(n=1;n<9;n++) B[n]=Bp[n]−B[n−1];
for(n=0;n<9;n++)

{

X[2*n]=A[n];
X[2*n+1]=B[n];
}

}
//=================================
//=================================
// 36-18 DCT, standard
//=================================
void MDCT3618(double *a, double *A)
{
int n,k;
double s;
for(n=0;n<18;n++)

{

s=0;
for(k=0;k<36;k++)

{

s+=a[k]*Cos3618[n][k];
}

A[n]=s;
}

}
//=================================
//=================================
// 36-18 DCT, fast
//=================================
void MDCT3618F(double *y, double *Y)
{
int n,k;
double x[18],Yp[18];
for(k=0;k<9;k++)

x[k]=(−y[26−k]−y[27+k])*Cos3618F[k];

for(k=9;k<18;k++)

x[k]=( y[k−9 ]−y[26−k])*Cos3618F[k];

DCT1818F(x,Yp);
y[0]=Yp[0]/2;
for(n=1;n<18;n++) Y[n]=Yp[n]−Y[n−1];
}
//=================================
//=================================
// 18-36 IMDCT, standard
//=================================
void IMDCT1836(double *Y, double *y)
{
int n,k:
double s;
for(n=0;n<36;n++)

{

s=0;
for(k=0;k<18;k++)

{

s+=Y[k]*Cos3618[k][n];//share

with the same table as 3618

{

y[n]=s;
}

}
//=================================
//=================================
// 36-18 DCT, fast
//=================================
void IMDCT1836F(double *Y, double *y)
{
int n,k;
double Yp[18],yppp[18],yp[36],s;
for(k=0;k<18;k++)

Yp[k]=Y[k]*Cos3618F[k];//the same table

DCT1818F(Yp,yppp);
for(n=0;n<9;n++) yp[n]=yppp[n+9];
for(n=9;n<10;n++) yp[n]=0;
for(n=10;n<27;n++) yp[n]=−yppp[27−n];
for(n=27;n<36;n++) yp[n]=−yppp[n−27];
s=0;
//for(k=0;k<18;k++) s+=Yp[k];
for(k=0;k<18;k++) s+=Y[k]*Cos1836F[k];
y[0]=s;
for(n=1;n<36;n++) y[n]=yp[n]−y[n−1];
}
//=================================
//***************************************
File name: dct_lib.h
//***************************************
#ifndef lib_dctH
#define lib_dctH
//=================================
void build_costab(void);
void DCT99 (double *a, double *A);
void DCT99W(double *a, double *A);
void DCT1818 (double *a, double *A);
void DCT1818F(double *a, double *A);
void MDCT3618 (double *a, double *A);
void MDCT3618F(double *a, double *A);
void IMDCT1836 (double *Y, double *y);
void IMDCT1836F(double *Y, double *y);
#endif

What is claimed is:

1. A method performed by a computer for computing modified discrete cosine transfer comprising the steps of:
$$computing x ( k ) = \{ \begin{matrix}[ - y ( 26 - k ) - y ( 27 + k ) ] \cdot {b}_{k} & for 0 \leq k \leq 8 \\ [ y ( k - 9 ) - y ( 26 - k ) ] \cdot {b}_{k} & for 9 \leq k \leq 17\end{matrix} . ; \\ computing {Y}^{′} ( n ) = {\sum }_{k = 0}^{17} x ( k ) cos [ \frac{π}{36} ( 2 k + 1 ) n ] for 0 \leq n \leq 17 ;$$
defining Y(0)=Y′(0)/2; and
computing Y(n)=Y′(n)−Y(n−1) for 1≦n≦17.

2. An MPEG encoder/decoder comprising:
$$means for computing x ( k ) = \{ \begin{matrix}[ - y ( 26 - k ) - y ( 27 + k ) ] \cdot {b}_{k} & for 0 \leq k \leq 8 \\ [ y ( k - 9 ) - y ( 26 - k ) ] \cdot {b}_{k} & for 9 \leq k \leq 17\end{matrix} . ; \\ means for computing {Y}^{′} ( n ) = {\sum }_{k = 0}^{17} x ( k ) cos [ \frac{π}{36} ( 2 k + 1 ) n ] for 0 \leq n \leq 17 ;$$
means for defining Y(0)=Y′(0)/2; and
means for computing Y(n)=Y′(n)−Y(n−1) for 1≦n≦17.

3. The encoder/decoder of claim 2, further comprising:
means for computing Y′(k)=Y(k)·bₖ for 0≦k≦17;
$$means for computing {y}^{′′′} ( n ) = {\sum }_{k = 0}^{17} {Y}^{′} ( k ) cos [ \frac{π}{2 * 18} ( 2 k + 1 ) n ] for 0 \leq n \leq 17 ;$$
$$means for computing {y}^{′} ( n ) = \{ \begin{matrix}{y}^{′′′} ( n + 9 ) & for & 0 \leq n \leq 8 \\ 0 & for & n = 9 \\ - {y}^{′′′} ( 27 - n ) & for & 10 \leq n \leq 26 \\ - {y}^{′′′} ( n - 27 ) & for & 27 \leq n \leq 35\end{matrix} ; \\ means for defining y ( 0 ) = {\sum }_{k = 0}^{18 - 1} Y ( k ) \cdot {c}_{k} ; and \\ means for computing y ( n ) = {y}^{′} ( n ) - y ( n - 1 ) for 1 \leq n \leq 35.$$

4. An electronic circuit for fast computation of modified inverse discrete cosine transform comprising:
$$a first circuit for computing$$
$$x ( k ) = \{ \begin{matrix}[ - y ( 26 - k ) - y ( 27 + k ) ] \cdot {b}_{k} for 0 \leq k \leq 8 \\ [ y ( k - 9 ) - y ( 26 - k ) ] \cdot {b}_{k} for 9 \leq k \leq 17\end{matrix} . ; \\ a second circuit for computing \\ {Y}^{′} ( n ) = {\sum }_{k = 0}^{17} x ( k ) cos [ \frac{π}{36} ( 2 k + 1 ) n ] for 0 \leq n \leq 17 ;$$
a third circuit for defining Y(0)=Y′(0)/2 ; and
a fourth circuit for computing Y(n)=Y′(n)−Y(n−1) for 1≦n≦17.

5. A method performed by a computer for computing modified inverse discrete cosine transform comprising the steps of:
computing Y′(k)=Y(k)·bₖ for 0≦k≦17;
$$computing {y}^{′′′} ( n ) = {\sum }_{k = 0}^{17} {Y}^{′} ( k ) cos [ \frac{π}{2 * 18} ( 2 k + 1 ) n ] for 0 \leq n \leq 17 ;$$
$$computing {y}^{′} ( n ) = \{ \begin{matrix}{y}^{′′′} ( n + 9 ) & for & 0 \leq n \leq 8 \\ 0 & for & n = 9 \\ - {y}^{′′′} ( 27 - n ) & for & 10 \leq n \leq 26 \\ - {y}^{′′′} ( n - 27 ) & for & 27 \leq n \leq 35\end{matrix} ; \\ defining y ( 0 ) = {\sum }_{k = 0}^{18 - 1} Y ( k ) \cdot {c}_{k} ; and \\ computing y ( n ) = {y}^{′} ( n ) - y ( n - 1 ) for 1 \leq n \leq 35.$$

6. An electronic circuit for fast computation of computing modified inverse discrete cosine transform comprising:
a first circuit for computing Y′(k)=Y(k)·bₖ for 0≦k≦17
$$a second circuit for computing {y}^{′′′} ( n ) = {\sum }_{k = 0}^{17} {Y}^{′} ( k ) cos [ \frac{π}{2 * 18} ( 2 k + 1 ) n ] for 0 \leq n \leq 17$$
$$a third circuit for computing {y}^{′} ( n ) = \{ \begin{matrix}{y}^{′′′} ( n + 9 ) & for & 0 \leq n \leq 8 \\ 0 & for & n = 9 \\ - {y}^{′′′} ( 27 - n ) & for & 10 \leq n \leq 26 \\ - {y}^{′′′} ( n - 27 ) & for & 27 \leq n \leq 35\end{matrix} \\ a fourth circuit for defining y ( 0 ) = {\sum }_{k = 0}^{18 - 1} Y ( k ) \cdot {c}_{k} ; and \\ a fifth circuit for computing y ( n ) = {y}^{′} ( n ) - y ( n - 1 ) for 1 \leq n \leq 35.$$
